(19) United States
(12) Patent Application Publication
(10) Pub. No.: US 2007/0028949 A1
(43) Pub. Date: Feb. 8, 2007

(54) Device and method for washing an automobile

(76) Inventor: Harvey Gylum Feltman, Canon, GA (US)

Correspondence Address: ANDREW F. KNIGHT, 2770 AIRLINE GOLDMINE RD., CANON, GA, 30520, US

(21) Appl. No.: 11/496,070

(22) Filed: Jul. 31, 2006

Related U.S. Application Data
(60) Provisional application No. 60/705,722, filed on Aug. 4, 2005.

(51) Int. Cl. B08B 3/00

(52) U.S. Cl. 134/45

(57) ABSTRACT

A method of washing an automobile includes providing a tire shield, the tire shield including a base, two side walls connected to the base, a back wall connected to the base, the back wall having an upper edge, and a tongue connected to each of the side walls extending above the upper edge of the back wall. The method includes placing the tire shield against a tire of an automobile so that at least a portion of the base abuts against the tire and at least one of the upper edge and the tongues abuts against the tire, providing a hose connected to a water source, and washing the automobile.

### REFERENCE TO RELATED APPLICATIONS

The present application claims priority to U.S. Provisional Patent Application No. 60/705,722, filed Aug. 4, 2005, entitled “Device and Method for Washing an Automobile,” the disclosure of which is hereby incorporated by reference.

### BACKGROUND

Most people wash their automobiles using a sponge, a bucket of soapy water, and a garden hose. The garden hose often used to wet the automobile prior to scrubbing with the sponge, as well as to rinse the car of soapy water after the scrubbing.

### SUMMARY OF THE INVENTION

One problem arises in the use of a typical garden hose. As the user moves around the automobile to spray different areas of the automobile, a portion of the hose will often slide under a tire and get pinched or stuck at the intersection of the tire with the ground. The hose will then be stuck, and further extension impossible, until the user frees the hose from underneath the tire. Such an event occurs many times during a car washing, and becomes frustrating and time consuming.

### BRIEF DESCRIPTION OF THE DRAWINGS

FIG. 1 shows a top view of a pair of tire shields according to an embodiment of the present invention.

FIG. 2 shows a front view of a tire shield according to an embodiment of the present invention.

FIG. 3 shows a top view of a tire shield according to an embodiment of the present invention.

FIG. 4 shows a side view of a tire shield according to an embodiment of the present invention.

FIG. 5a shows a top view of a tire shield according to an embodiment of the present invention.

FIG. 5b shows a side view of a tire shield according to an embodiment of the present invention.

FIG. 5c shows a back view of a tire shield according to an embodiment of the present invention.

FIG. 6 shows a perspective view of a tire shield mated with a tire of an automobile.

### DETAILED DESCRIPTION

In the following description, the use of “a,” “an,” or “the” can refer to the plural. All examples given are for clarification only, and are not intended to limit the scope of the invention.

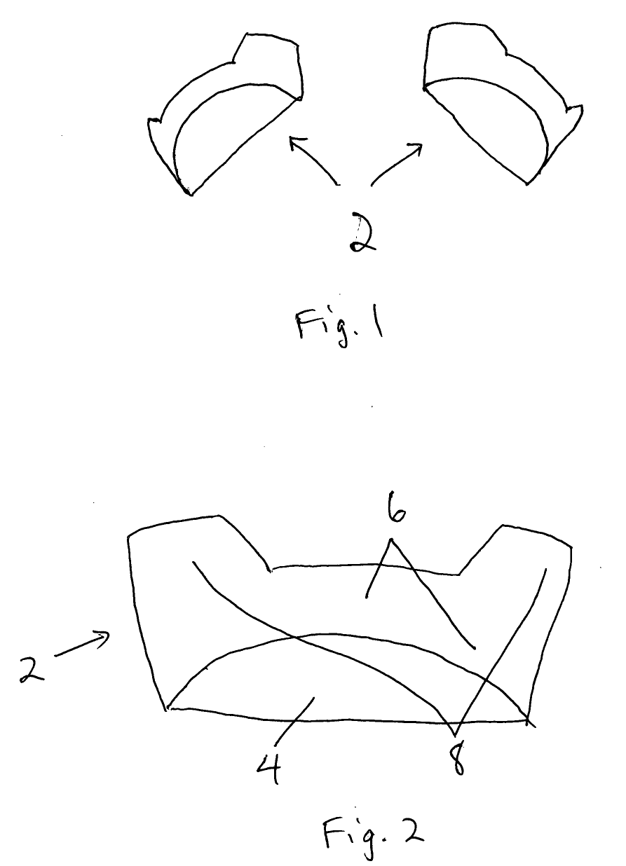

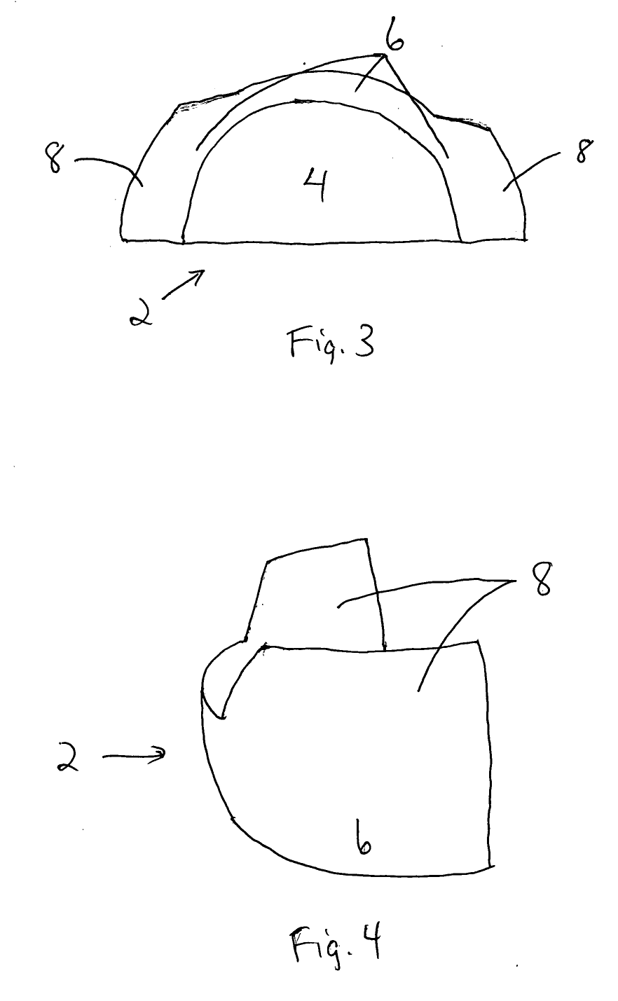

Referring now to FIGS. 1-4, a tire shield 2 comprises a semicircular base 4, a semicylindrical wall 6 connected to the base 4, and a pair of tongues 8 connected to the wall 6. The base 4, wall 6, and tongues 8 are preferably (but need not be) integrally formed, and comprise a hard, sturdy material, such as a metal, ceramic, glass or fiberglass, polymer, or plastic. At least an outer surface of the wall 6 and/or tongues 8 may comprise a low-friction material, or be coated with a low-friction material. Low friction materials, such as Teflon™, are well known in the art.

The base 4 has a diameter or longest dimension of approximately 8 inches to 16 inches, preferably approximately 10 inches to 14 inches, preferably approximately one foot. In one embodiment, the base 4 may have a shape different than that shown, such as a crescent, or a circle sliced by a chord, or a filled parabolic shape, etc. Any shape that will provide support for the wall 6 is within the scope of the present invention. Where the wall 6 is sufficiently rigid by itself, the base 4 may be omitted substantially or entirely. As an example of another alternative, base 4 may comprise a strip of material spanning the distance from one end of the wall 6 to the other end, in order to provide support and/or structure.

The wall 6 has a height of approximately 2 to 6 inches, preferably approximately 3 to 5 inches, and preferably approximately 4 inches. While shown in the drawings as semicylindrical, the wall 6 may have any shape, but preferably a rounded shape, to allow easy sliding of a garden hose about its perimeter. For example, the wall 6 may have the shape of an extruded elliptical section, extruded parabolic section, or an extruded arc having varying radii of curvature.

The tongues 8 may be parallelograms or trapezoids or simple quadrilaterals. (As shown in the drawings, they are trapezoidal.) They may alternatively be triangular in shape. The tongues 8 may each have a height of approximately 2 to 6 inches, preferably approximately 3 to 5 inches, and preferably approximately 4 inches. In one embodiment of the tire shield 2, the tongues 8 may be omitted entirely. Where included, tongues 8 may have the same or similar curve as the wall 6 to which they are attached (as shown in the drawings).

In operation, a tire shield 2 is wedged at the bottom of an automobile tire, so that an outer edge of the base 4 abuts against the point of contact of the tire with the ground, and/or so that an upper edge of the wall 6 contacts the tire. The outer edge of the base 4 will then be approximately parallel to the axis of rotation of the tire, and the wall 6 will face away from the automobile—e.g., forward if the tire shield 2 is used on a front tire, and backward if the tire shield 2 is used on a rear tire. The user may then shield the remaining tires of the automobile using similar tire shields 2. Then, the user may proceed to wash the automobile as he is used to. However, because of the placement of the tire shields 2, and because an outer surface of the tire shields 2 has a low friction coefficient, the garden hose readily passes around a tire, as the user pulls on the hose, without getting stuck or pinched by the tire.

In another embodiment, an intersection between the wall 6 and base 4 need not be a sharp right angle, as shown, but may curve (not shown). The curve may have a radius of curvature approximately matching that of a typical automobile tire, so that the tire shield 2 fits snugly against a tire.

In another embodiment, the wall 6 may comprise a groove or rounded indentation (not shown) in its outer surface, so that the garden hose preferentially slides along the groove/indentation when the user pulls the hose around the tire shield 2. An advantage to such a feature is to cause the hose to slide along the low-friction groove/indentation without contacting the ground, which may have a higher sliding friction coefficient.

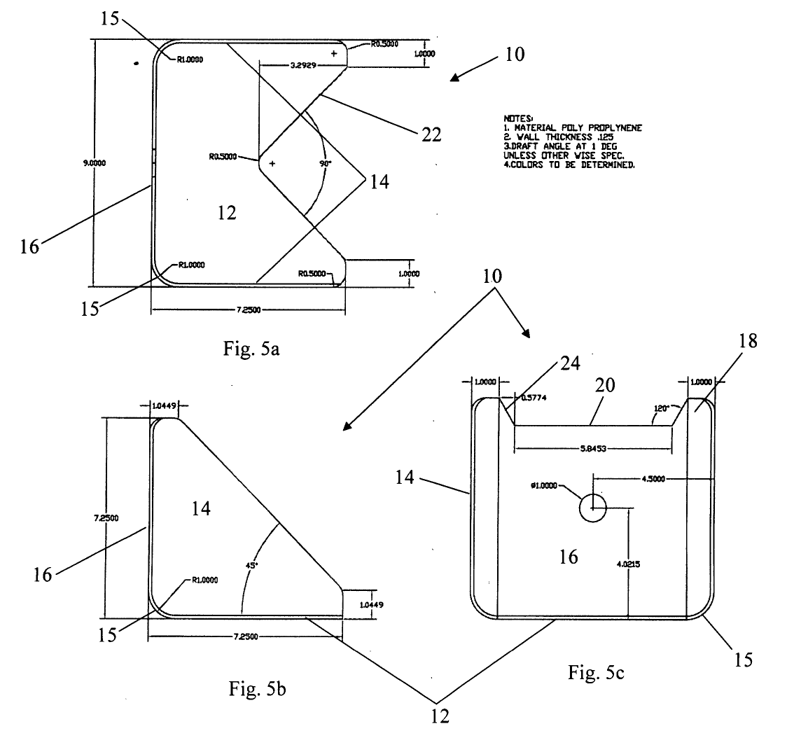

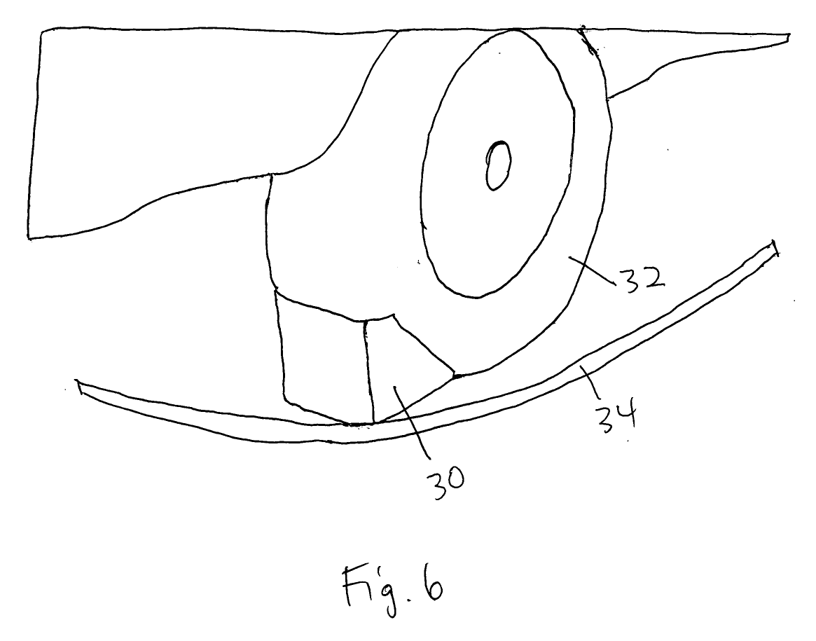

Referring now to FIGS. 5a-5c, a tire shield 10 comprises a base 12, two side walls 14 connected to the base 12, a back wall 16 connected to the side walls 14 and the base 12, and a pair of tongues 18 connected to the side walls 14 (and, in an embodiment, at least partially connected to the back wall 16, as shown in FIG. 5c). Each of the base and walls 12, 14, 16 may be connected at a rounded edge 15. The tire shield 10 may have any of the features previously discussed with respect to tire shield 2 in FIGS. 1-4, such as shape, composition, and/or dimensions.

The base 12 may comprise a groove or cut-out 22, allowing the tire shield 10 to easily and snugly fit underneath a tire and to allow an upper edge 20 of back wall 16 to abut against the tire. The cut-out 22 may be substantially triangular, as shown, or may have any other shape, such as a semicircle, arc, or rectangle.

Back and side walls 14, 16 may be substantially flat, or may have an arc and/or rounded shape, for example to accommodate the slightly rounded cross sectional shape of a tire.

Tongues 18 may extend above upper edge 20 of back wall 16, and may be connected to the upper edge 20 via slopes 24. Slopes 24 may be angled with respect to upper edge 20 at an angle between 90° and 180°, preferably between 110° and 150°, and preferably approximately 120°. The combination of upper edge 20, tongues 18, and slopes 24, in conjunction with the shape of cut-out 22, serve to allow tire shield 10 to snugly enshroud a tire, for a variety of different tire sizes. For example, for large tires, the distance between side walls 14 is sufficient to allow tire shield 10 to be placed underneath the tire, with side walls 14 snugly fitting around both sides of the tire. As shown in FIG. 5c, this distance may be double the shown dimension of 4.5000 inches, or about 9 inches, although the distance may range from about 7 to 11 inches, and more preferably from about 8 to 10 inches. Further, for a large tire, an upper edge of the tongues 18 may abut against the tire, instead of the upper edge 20 of back wall 16.

For a smaller tire, having a width substantially smaller than the distance between side walls 14, the upper edge 20 (and/or a portion of the slopes 24, depending on the width of the tire) may abut against the tire, and side walls 14 may not touch the tire. Further, a portion of the cut-out 22 may abut against a bottom portion of the tire. The tire shield 10 may have any of the dimensions shown, which may also vary in a range of 20%, and more preferably in a range of 10%.

Referring now to FIG. 6, a tire shield 30 abuts against a tire 32 of an automobile. A hose 34 connected to a water source (not shown) moves freely around the tire 32 because of interaction with the tire shield 30.

Most of the embodiments described herein have represented simple versions for clarity of explanation. As understood by one of ordinary skill in the art, many of the features and/or aspects of the embodiments described herein may be “mixed and matched” to the extent physically possible to satisfy individual design requirements.

I claim:

1. A method of washing an automobile, comprising:
providing a tire shield, the tire shield comprising:
a base;
two side walls connected to the base;
a back wall connected to the base, the back wall comprising an upper edge; and
a tongue connected to each of the side walls extending above the upper edge of the back wall;
placing the tire shield against a tire of an automobile so that at least a portion of the base abuts against the tire and at least one of the upper edge and the tongues abuts against the tire;
providing a hose connected to a water source; and
washing the automobile.

2. The method as claimed in claim 1, wherein an outer surface of the back wall comprises a low-friction material.

3. The method as claimed in claim 1, wherein the base comprises a cut-out portion.

4. The method as claimed in claim 3, wherein the cut-out portion has a substantially triangular shape.

5. The method as claimed in claim 1, wherein the back wall and side walls are connected via rounded edges.

6. The method as claimed in claim 1, wherein the upper edge is connected to each of the tongues via a slope that is angled relative to the upper edge at between approximately 110° and 150°.

7. The method as claimed in claim 1, further comprising pulling the hose around the tire along the back wall of the tire shield.
